(19) United States
(12) Patent Application Publication
(10) Pub. No.: US 2009/0064814 A1
(43) Pub. Date: Mar. 12, 2009

(54) STEERING COLUMN DEVICE

(75) Inventor: Seiji TANAKA, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/205,184

(22) Filed: Sep. 5, 2008

(30) Foreign Application Priority Data
Sep. 6, 2007 (JP) 2007-231712

(51) Int. Cl. B62D 1/18

(52) U.S. Cl. 74/493

(57) ABSTRACT

A tilt adjust nut is inserted in a first recess formed in a tube guide bracket, and is coupled to a column body around an axis perpendicular to a tilt plane thereof. When the column body tilts with respect to an upper bracket due to tilt operation and the tilt angle of the column body with respect to the upper bracket changes due to this tilting of the column body, the tilt adjust nut rotates in the first recess in accordance with the tilting of the column body and thereby allows changes in the tilt angle.

### INCORPORATION BY REFERENCE

The disclosure of Japanese Patent Application No. 2007-231712 filed on Sep. 6, 2007 including the specification, drawings and abstract is incorporated herein by reference in its entirety.

### BACKGROUND OF THE INVENTION

1. Field of the Invention

The invention relates to a steering column device. In particular, the invention relates to a steering column device equipped with an electric tilt mechanism for adjusting the vertical position of a steering wheel by vertically tilting a steering column body.

2. Description of the Related Art

There is known a vehicle equipped with a tilt mechanism for adjusting the vertical position of a steering wheel with respect to the vehicle in accordance with the driver's build or driving posture, or a telescoping mechanism for adjusting the longitudinal position of the steering wheel with respect to the vehicle in accordance with the driver's build or driving posture. In recent years there is also known a vehicle mounted with an electric tilt mechanism for adjusting the vertical position of a steering wheel by means of an electric actuator such as an electric motor or the like, or an electric telescoping mechanism for adjusting the longitudinal position of the steering wheel by means of an electric actuator such as an electric motor or the like. The structure of an electric tilt mechanism is described in Japanese Patent Application Publication No. 2002-002503 (JP-A-2002-002503), Japanese Patent Application Publication No. 2002-193110 (JP-A-2002-193110), and Japanese Patent Application Publication No. 2007-015678 (JP-A-2007-015678).

The electric tilt mechanism mounted on the steering column device described in JP-A-2002-002503, JP-A-2002-193110, and JP-A-2007-015678 is constructed such that a bracket supporting a steering column body tilts in response to the tilting of the steering column body. Thus, the bracket is fixed to a vehicle body via a hinge to facilitate tilting of the steering column. The steering column device described in JP-A-2002-002503, JP-A-2002-193110, and JP-A-2007-015678 is provided with the hinge as described above. Therefore, there is a problem in that the number of components constituting the electric tilt mechanism is large. Further, the hinge is provided between the steering column body and the vehicle body. Therefore, there is a problem in that the steering column device is large in size.

### SUMMARY OF THE INVENTION

The invention provides a steering column device including an electric tilt mechanism that requires fewer components and makes a contribution to size reduction possible.

One aspect of the invention relates to a steering column device. The steering column device is equipped with a steering column body, a lower bracket, an electric tilt mechanism, and an upper bracket. The steering column body has a steering main shaft coupled to a steering wheel, and a support member that rotatably supports the steering main shaft. The lower bracket is fixed to a vehicle body, and vertically tiltably supports the steering column body with respect to the vehicle body. The electric tilt mechanism vertically tilts the steering column body with respect to the vehicle body around the point where the steering column body is supported by the lower bracket. The upper bracket is mounted on the vehicle body, and supports the portion of the steering column body behind the lower bracket in the longitudinal direction of the vehicle, to allow the steering column body to tilt as described above.

Further, the electric tilt mechanism is equipped with a tilt screw, an electric actuator, and a tilt adjust nut. The tilt screw extends perpendicularly to or at a slant with respect to the column axis of the steering column body, has a male thread provided along an outer periphery thereof and is rotatably and axially immovably supported by the upper bracket. The electric actuator rotationally drives the tilt screw. The tilt adjust nut has a threaded hole having a female thread provided along an inner periphery thereof, and is screwed onto the tilt screw. A first recess, in which the tilt adjust nut is inserted, is formed in the support member, and the tilt adjust nut is rotatably coupled to the support member around an axis perpendicular to a tilt plane of the steering column body in the first recess.

According to the steering column device described above, when the tilt screw rotates in response to the driving of the electric actuator, the tilt adjust nut screwed onto the tilt screw is fed through this rotation. Thus, the tilt adjust nut moves in an axial direction of the tilt screw, namely, perpendicularly to or at a slant with respect to the column axis direction of the steering column body (parallel to an axial direction of the steering main shaft). Accordingly, the tilt adjust nut is coupled to the support member in the first recess. Therefore, the support member moves together with the tilt adjust nut as the tilt adjust nut moves as described above. Due to the movement of the support member, the steering column body vertically tilts with respect to the vehicle body around the support point where the steering column body is supported by the lower bracket. Thus, the tilt operation of the steering column body is performed.

The steering column body may be tilted with respect to the upper bracket through the tilting operation, and the tilting of the steering column body causes changes in a support angle (tilt angle) at which the steering column body is supported by the upper bracket. It should be noted herein that the tilt adjust nut may rotate about the axis perpendicular to the tilt plane of the steering column body (around an axis parallel to a tilt axis thereof) in the first recess of the support member. Accordingly, the tilt adjust nut rotates in the first recess in accordance with the tilting of the steering column body, and the above-mentioned support angle is thereby allowed to change. That is, the tilt adjust nut essentially functions as a hinge member to allow the steering column body to tilt. Therefore, unlike conventional steering column devices, a separate hinge is not necessary. As a result, the number of components of the steering column device is reduced. In addition, there is no need to ensure sufficient space for mounting the hinge member either. Therefore, the device may be made more compact.

### BRIEF DESCRIPTION OF THE DRAWINGS

The foregoing and further features and advantages of the invention will become apparent from the following description of an example embodiment with reference to the accompanying drawings, wherein like numerals are used to represent like elements and wherein:

FIG. 1 is a lateral view of a steering column device according to the embodiment of the invention;

FIG. 2 is a plan view of the steering column device shown in FIG. 1;

FIG. 3 is a sectional view taken along a line III-III of FIG. 2;

FIG. 4 is an enlarged sectional view taken along a line IV-IV of FIG. 1;

FIGS. 5A to 5E are views showing a tube guide bracket shown in FIG. 4, FIG. 5A being a front view of the tube guide bracket, FIG. 5B being a left lateral view of the tube guide bracket, FIG. 5C being a right lateral view of the tube guide bracket, FIG. 5D being a bottom view of the tube guide bracket, and FIG. 5E being a sectional view taken along a line G-G of FIG. 5C;

FIGS. 6A and 6B are views showing a tilt adjust nut shown in FIG. 4, FIG. 6A being a front view of the tilt adjust nut and FIG. 6B being a sectional view of the tilt adjust nut;

FIG. 7 is a partial sectional view taken along a line VII-VII of FIG. 1;

FIG. 8 is a sectional view taken along a line VIII-VIII of FIG. 1;

FIG. 9 is a partial sectional view taken along a line IX-IX of FIG. 1; and

FIG. 10 is a sectional view taken along a line X-X of FIG. 1.

### DETAILED DESCRIPTION OF EXAMPLE EMBODIMENT

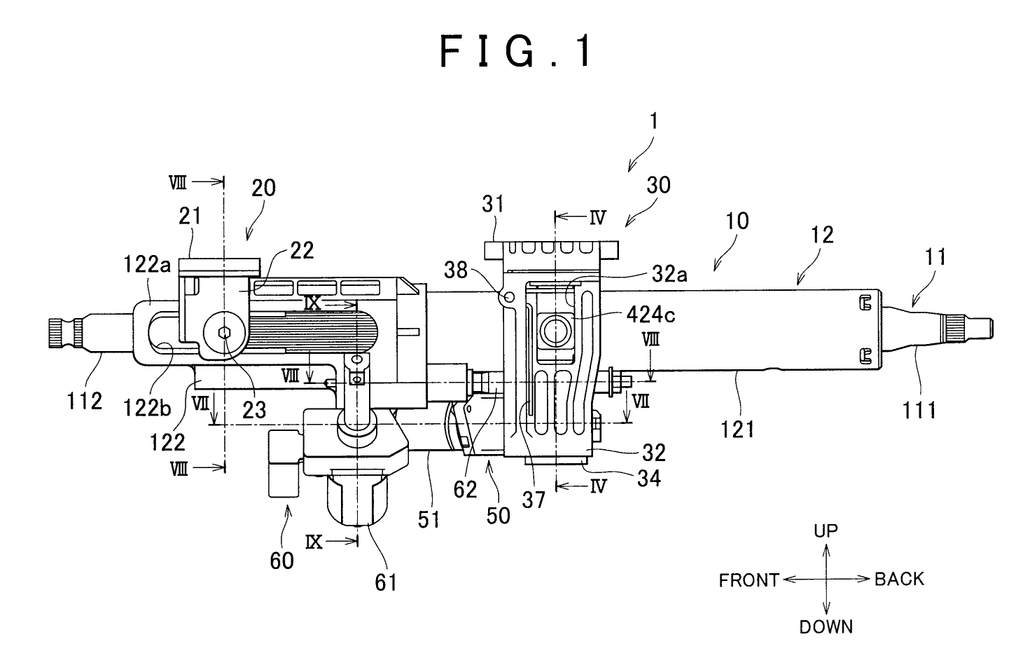

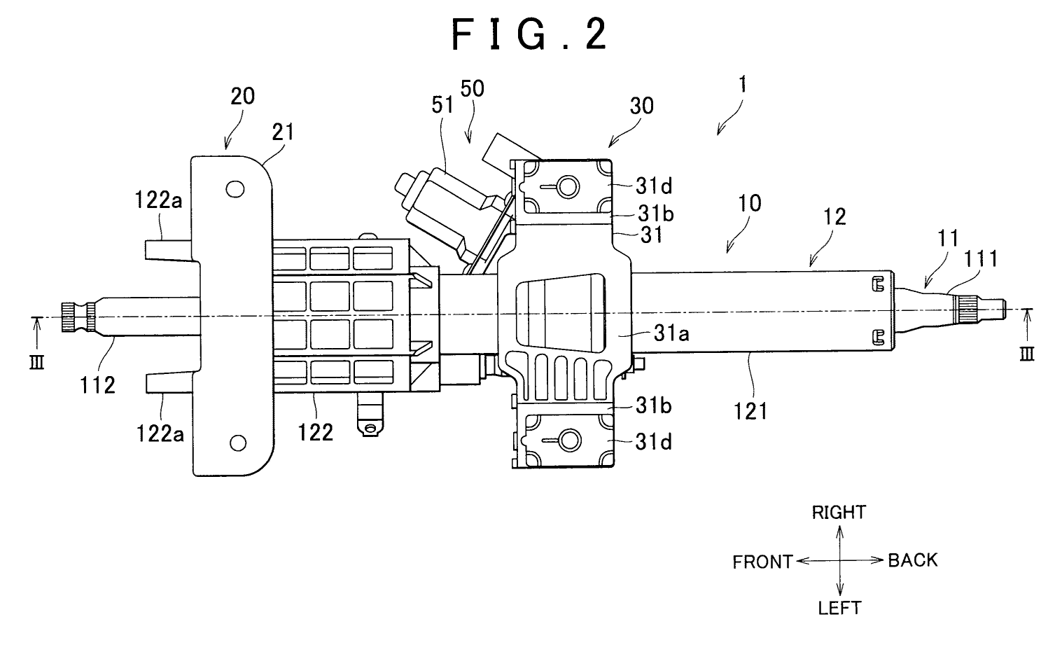

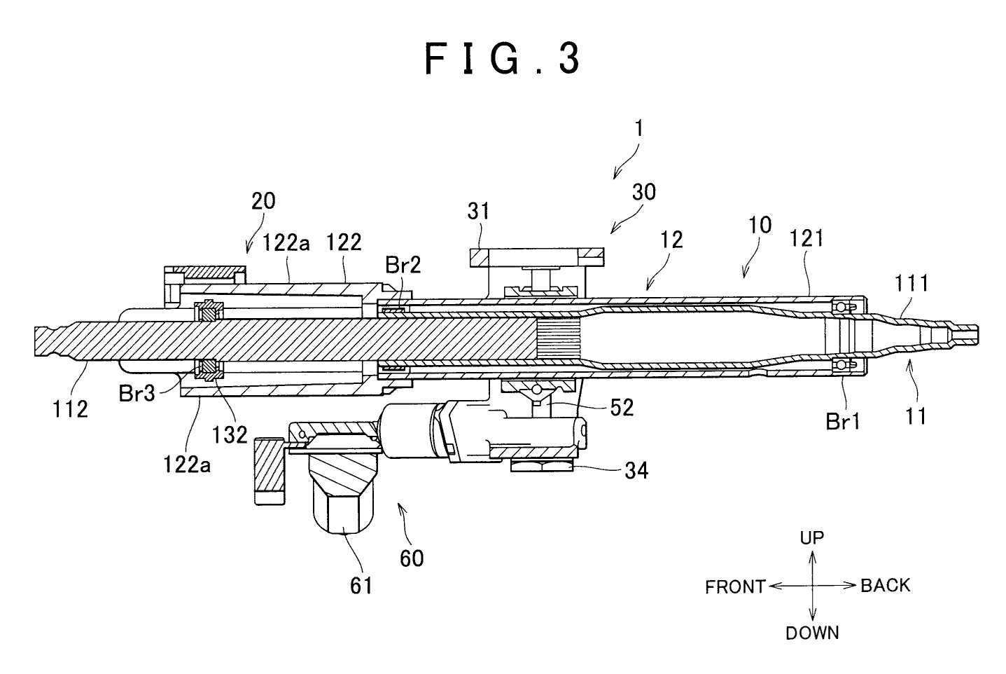

A steering column device according to an example embodiment of the invention will be described below with reference to the drawings. FIG. 1 is a lateral view of a steering column device according to the embodiment of the invention. FIG. 2 is a plan view of the steering column device shown in FIG. 1. FIG. 3 is a sectional view taken along a line III-III of FIG. 2. As shown in FIG. 1, a steering column device 1 has a steering column body (hereinafter referred to as the column body) 10, a lower bracket 20, and an upper bracket 30.

The column body 10 includes a steering main shaft 11 and a column tube 12. As shown in FIGS. 1 and 3, the steering main shaft 11 has an upper shaft 111, the rear end of which is coupled to a steering wheel (not shown), and a lower shaft 112, the front end of which is coupled to an intermediate shaft (not shown) via a universal joint (not shown). As shown in FIG. 3, the upper shaft 111 is formed in the shape of a tube, and the lower shaft 112 is formed in the shape of a rod. Further, as shown in FIG. 3, a front end of the upper shaft 111 is spline-fitted to a rear end of the lower shaft 112. Thus, both the upper and lower shafts 111 and 112 are coupled to each other integrally rotatably and axially relatively movably.

As shown in FIG. 3, the column tube 12 is divided into a tube body 121 and a yoke portion 122. The tube body 121 and the yoke portion 122 are integrally operably coupled to each other. The tube body 121 covers the outer periphery of the upper shaft 111, and rotatably and axially relatively immovably supports, on the inner periphery side thereof, the upper shaft 111 via a bearing Br1 and a bearing Br2. As shown in FIG. 3, the yoke portion 122 is coupled to a front-side end of the tube body 121. As shown in FIG. 3, the yoke portion 122 is formed in tubular shape, and encases the outer periphery of the lower shaft 112. As shown in FIG. 2, arm portions 122a are disposed on the front side of the yoke portion 122 to either side of the lower shaft 112. As shown in FIG. 1, slit holes 122b that extend along a column axis direction of the column body 10 are formed through the lateral sides of each arm portion 122a.

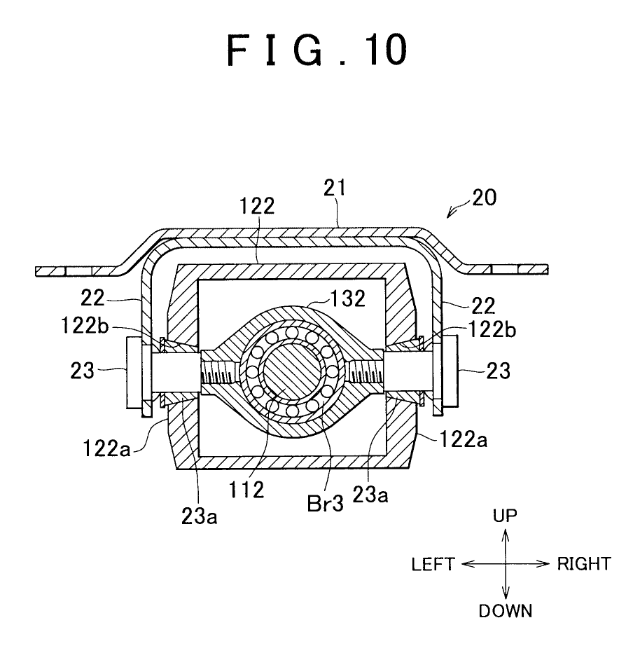

As shown in FIG. 1, the lower bracket 20 is disposed on the front side of the column body 10. The lower bracket 20 includes an upper mounting portion 21 and a pair of support portions 22 and 22. The upper mounting portion 21 is a region that extends laterally (see FIG. 2), namely, perpendicularly to the column axis direction above the column body 10, and is mounted to a vehicle body. As shown in FIG. 10, the pair of the support portions 22 and 22 extend downward from the upper mounting portion 21 and sandwich the column tube 12 (the yoke portion 122).

FIG. 10 is a sectional view taken along a line X-X of FIG. 1, showing an assembled state in the vicinity of the lower bracket. As shown in FIG. 10, each of a pair of laterally extending tilt center pins 23 and 23 is turnably mounted on one end side thereof to a corresponding one of the pair of the support portions 22 and 22. Each of the pair of the tilt center pins 23 and 23 is inserted at the other end thereof to a corresponding slit hole 122b, which are formed in the arm portions 122a of the yoke portion 122 respectively, and is screwed at the other end thereof to a bearing case 132 disposed on the outer periphery of the lower shaft 112. A bearing Br3 is provided within the bearing case 132. The lower shaft 112 is coupled to the bearing case 132 by the bearing Br3. The lower shaft 112 is able to rotate freely about its own axis, but is stationary in the axial direction. Accordingly, the lower shaft 112 is rotatably and axially immovably supported by the lower bracket 20 via the bearing case 132 and the tilt center pins 23. The tilt center pins 23 rotate around the axes thereof with respect to the lower bracket 20, and the lower shaft 112 and the yoke portion 122 thereby vertically tilt as an integral unit around the tilt center pins 23. As described above, the column body 10 is tiltably supported by the lower bracket 20 with respect to the vehicle body. As shown in FIG. 10, wedge-shaped members 23a are mounted on the outer peripheries of each tilt center pin 23. Each wedge-shaped member 23a is fitted to a corresponding slit hole 122b having tapered face, and is urged by a leaf spring and a washer in a fitting direction. The yoke portion 122 is movable with respect to the lower bracket 20 in an axial direction of the lower shaft 112 while remaining in sliding contact with the wedge-shaped members 23a.

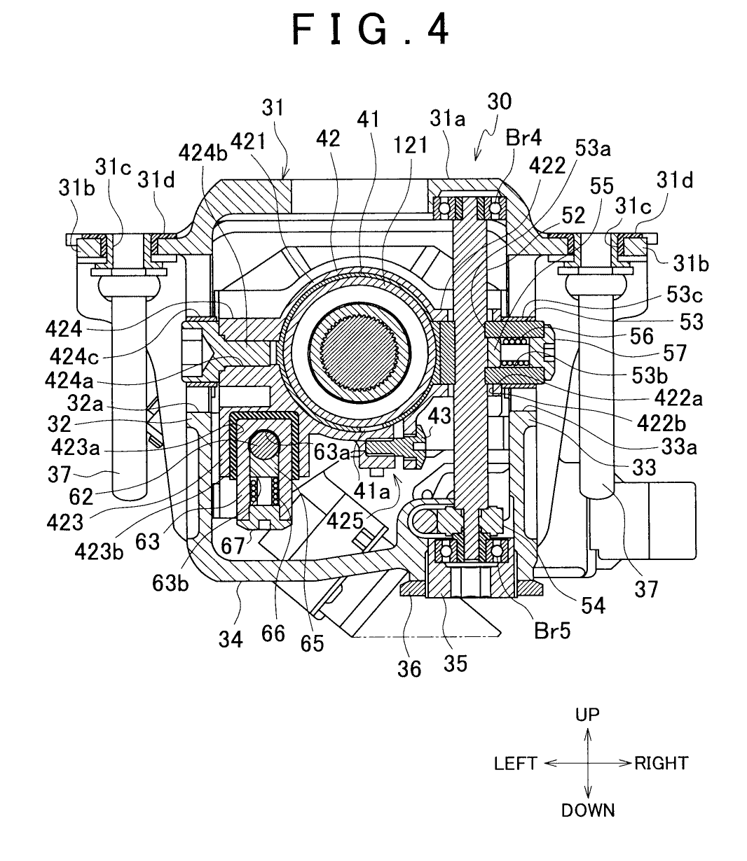

The upper bracket 30 supports the column body 10 behind the lower bracket 20 in a longitudinal direction of the vehicle. FIG. 4 is an enlarged sectional view taken along a line IV-IV of FIG. 1, showing the structure of the assembled upper bracket 30 and the column body 10. As shown in FIG. 4, the upper bracket 30 has an upper plate portion 31, a pair of lateral wall portions 32 and 33, and a bottom face portion 34, and surrounds the tube body 121 on all four sides. The upper plate portion 31 is disposed above the tube body 121 and laterally extended across the column body 10. The lateral wall portions 32 and 33 extend downward from the upper plate portion 31 to sandwich the tube body 121. The bottom face portion 34 couples the lateral wall portions 32 and 33 to each other below the column body 10. As shown in FIGS. 1 and 4, vertical slots 32a and 33a are formed in the respective the lateral wall portions 32 and 33.

Further, as shown in FIG. 4, a tube guide bracket 42 is mounted on the region of the tube body 121 that is surrounded by the upper bracket 30 via a tube guide bushing 41. The column body 10 is supported by an upper tube 30 via the tube guide bushing 41, the tube guide bracket 42, a tilt guide pin 424b, a tilt adjust nut 53, and tilt guide bushings 424c and 53c.

The tube guide bushing 41 has a generally cylindrically formed and surrounds the outer periphery of the tube body 121 over a predetermined length in an axial direction of the tube body 121. An axially notched slit 41a is formed in the tube guide bushing 41, thus the tube guide bushing 41 has a generally C-shaped cross-section. The tube guide bracket 42 is disposed on an outer periphery side of the tube guide bushing 41.

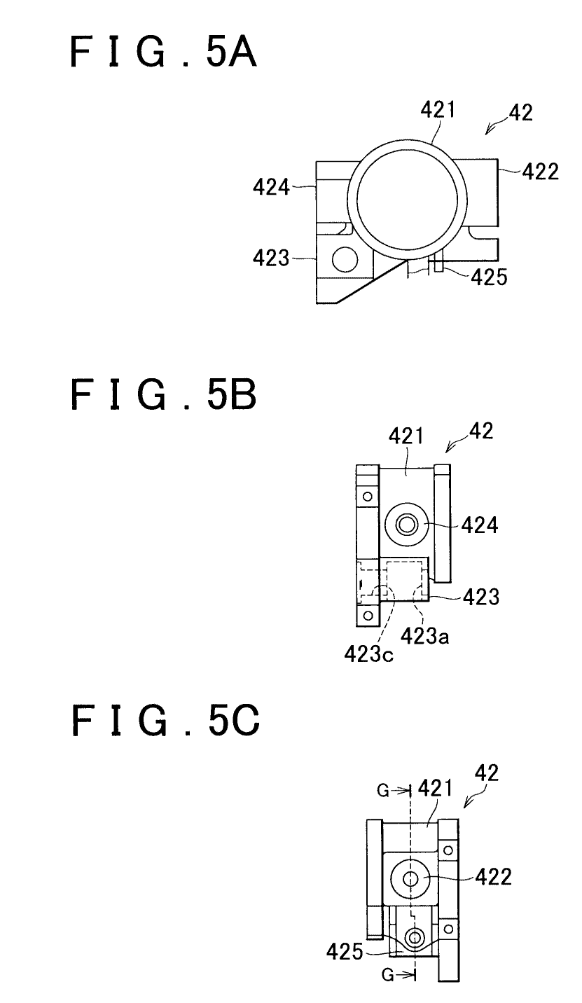

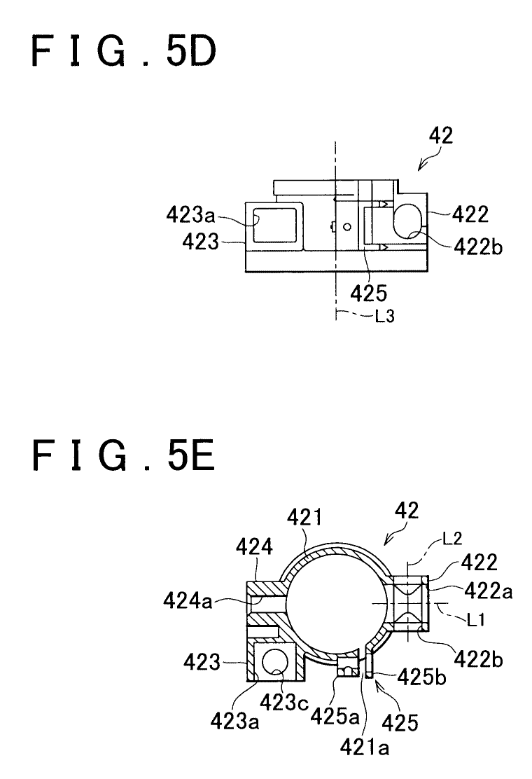

FIGS. 5A to 5E are views showing the tube guide bracket 42. FIG. 5A is a front view of the tube guide bracket as viewed from the back side of the vehicle. FIG. 5B is a left lateral view of the tube guide bracket. FIG. 5C is a right lateral view of the tube guide bracket. FIG. 5D is a bottom view of the tube guide bracket. FIG. 5E is a sectional view taken along a line G-G of FIG. 5C. As shown in FIG. 4 and FIGS. 5A to 5E, the tube guide bracket 42 is composed of a guide portion 421, a tilt tubular portion 422, a telescopic support portion 423, a mounting tubular portion 424, and a fastening portion 425. As shown in FIG. 5E, the guide portion 421 has a ring-shaped cross-section. The tilt tubular portion 422, the telescopic support portion 423, the mounting tubular portion 424, and the fastening portion 425 are formed around the guide portion 421.

As shown in FIG. 4, the guide portion 421 covers the outer periphery of the tube guide bushing 41, has a generally cylindrical shape, as with the tube guide bushing 41, and has a generally C-shaped cross-section with an axially extending slit 421a formed therein. As shown in FIGS. 4 and 5E, the fastening portion 425 is located below the guide portion 421, and is constructed with a pair of protruding strips 425a and 425b that extend downward from both edge portions of the guide portion 421, in which the slit 421a is formed, and face each other. As shown in FIG. 4, a fastening force along a circumferential direction is applied to the guide portion 421 by fastening the protruding strips 425a and 425b by a fastening bolt 43. Due to this fastening force, the tube body 121 is fastened via the tube guide bushing 41, and is coupled to the tube guide bracket 42. By adjusting this fastening force, the sliding load and backlash between the tube guide bushing 41 and the tube body 121 during telescoping operation may be adjusted. By fixing the fastening bolt 43 with an anti-loosening agent, a slotted set screw, or the like when an appropriate fastening force is obtained, the fastening force may be stabilized. It is also appropriate to provide a plurality of circular protruding portions of a predetermined length in the circumferential direction on an inner periphery side of the guide portion 421, and ensure that these protruding portions are in surface contact with the tube body 121. The column tube 12, the tube guide bushing 41, and the tube guide bracket 42 correspond to a support member that rotatably and axially immovably supports the steering main shaft 11.

In the assembled state shown in FIG. 4, the tilt tubular portion 422 extends rightward from a right-side lateral periphery of the guide portion 421, and is formed in the shape of a cylinder having a laterally extending axis. The direction of a cylinder axis L1 of the tilt tubular portion 422 shown in FIG. 5E is parallel to the lateral direction in the assembled state shown in FIG. 4. The direction of the cylinder axis L1 of the tilt tubular portion 422 is the same as the axial direction of the tilt center pins 23. The column body 10 tilts around the axes of the tilt center pins 23. Therefore, the tilt tubular portion 422 extends perpendicularly to a tilt plane when the column body 10 tilts with the tilt center pins 23 serving as support centers in the assembled state, namely, parallel to a tilt axis (the axial direction of the tilt center pins 23). Further, as shown in FIGS. 4 and 5E, a first recess 422a and a second recess 422b are formed in the tilt tubular portion 422.

As shown in FIGS. 4 and 5E, the first recess 422a is formed in the tilt tubular portion 422 along the axial direction, namely, perpendicular to the tilt plane of the column body 10 in the assembled state. The second recess 422b extends perpendicularly to both an axial direction of the first recess 422a and an axial direction of the guide portion 421 (along an axis L2 in FIG. 5E). The direction along the axis L2 coincides with the vertical direction in the assembled state shown in FIG. 4. As shown in FIG. 5E, the first recess 422a and the second recess 422b intersect with each other in the tilt tubular portion 422. Further, as shown in FIG. 5D, the second recess 422b is an elongate hole having a major axis extending in the axial direction of the guide portion 421 (an L3 direction). The guide portion 421 is disposed coaxially with the column body 10 when assembled with the column body 10. Therefore, the second recess 422b is an elongated hole having a major axis that extends in the column axis direction of the column body 10.

The telescopic support portion 423 is a region disposed to the left of and below the guide portion 421 in FIG. 4, and has a recess 423a with a rectangular cross-section that has been obtained by hollowing out the telescopic portion 423 in such a manner as to open downward as shown in FIGS. 5D and 5E. A telescopic adjust nut 63 is inserted into the recess 423a from the opening side thereof, and is elastically supported by the telescopic support portion 423 via an elastic body (e.g., rubber member) 423b to prevent slippage. In addition, as shown in FIG. 5E, a through-hole 423c is formed through the telescopic support portion 423 along the column axis direction. A telescopic screw 62 is inserted through this through-hole 423c. The mounting tubular portion 424, disposed symmetrically to the tilt tubular portion 422 across the guide portion 421 extends leftward from a left-side lateral periphery of the guide portion 421 in FIG. 4, and is formed in the shape of a cylinder having a laterally extending axis in the assembled state. In other words, the mounting tubular portion 424 is disposed coaxially with the tilt tubular portion 422. As shown in FIG. 4, a threaded hole 424a is provided in the mounting tubular portion 424 that extends along the axial direction. As shown in FIG. 4, the tilt guide pin 424b is screwed into the threaded hole 424a. A rectangular tilt guide bushing 424c is assembled with a head portion of the tilt guide pin 424b, and the tilt guide pin 424b is rotatably fixed to the tilt guide bushing 424c. As shown in FIG. 1, the tilt guide bushing 424c is fitted such that a lateral strip thereof is in slidable contact with a guide hole 32a formed through a lateral wall portion 32 of the upper bracket 30, and is assembled with the upper bracket 30 movably in the vertical direction in FIG. 1 and immovably in the longitudinal direction (the column axis direction).

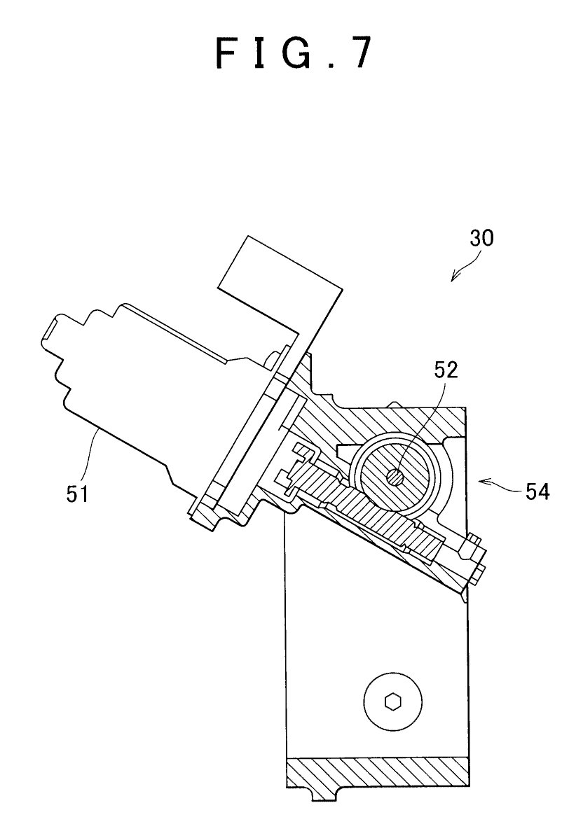

Further, as shown in FIG. 1, the steering column device 1 according to this embodiment of the invention is equipped with the electric tilt mechanism 50 and the electric telescoping mechanism 60, and is designed to automatically perform the tilt operation and the telescoping operation in response to the driving of an electric motor. As shown in FIG. 7, the electric tilt mechanism 50 is constructed with a tilt electric motor 51, a tilt screw 52, and the tilt adjust nut 53.

FIG. 7 is a partial sectional view taken along a line VII-VII of FIG. 1. As shown in FIGS. 1 to 3 and 7, the tilt electric motor 51 is fixed to the upper bracket 30. The tilt screw 52 is coupled to the tilt electric motor 51 via a speed reduction mechanism 54 such as a worm reducer or the like, which is composed of a worm shaft and a worm wheel. A male thread is provided along the outer periphery of the tilt screw 52, and is rotatably and axially immovably supported by the upper bracket 30 via a bearing Br4 fixed to the upper plate portion 31 of the upper bracket 30 and a bearing Br5 fixed to a bottom face portion 34 by a bearing case 35 and a lock nut 36, as shown in FIG. 4. In the state shown in FIG. 3, namely, in a neutral state, the axial direction of this tilt screw 52 is perpendicular to the column axis direction of the column body 10 on the tilt plane (a plane parallel to the sheet of FIG. 3) of the column body 10. The tilt screw 52 according to the invention is not limited to the aforementioned construction. It is sufficient that the tilt screw 52 according to the invention at least have a vertical component perpendicular to the column axis direction. For example, the tilt screw 52 may be disposed at a slant with respect to the column axis. Further, as shown in FIG. 4, the tilt screw 52 is inserted through the second recess 422b of the tilt tubular portion 422 of the tilt guide bracket 42.

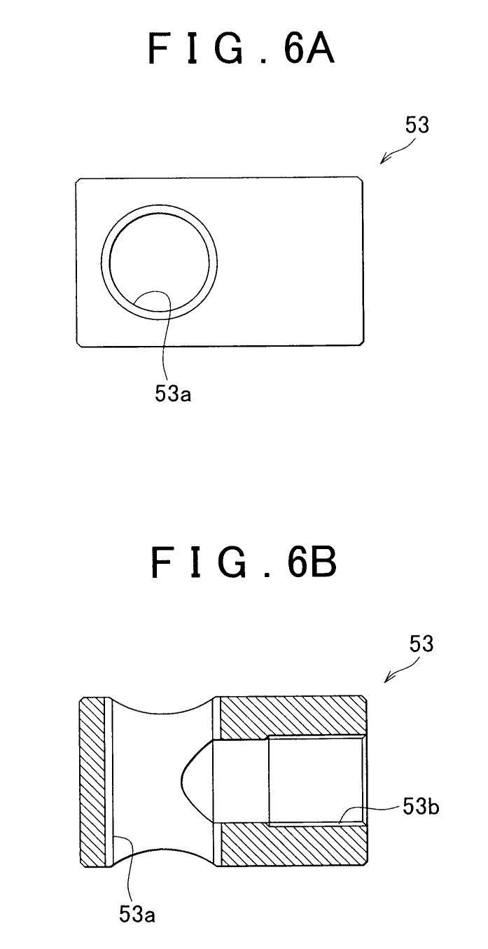

As shown in FIG. 4, the tilt adjust nut 53 is screwed onto the tilt screw 52, and is fed through rotation of the tilt screw 52. FIGS. 6A and 6B views show the tilt adjust nut 53. FIG. 6A is a front view of the tilt adjust nut 53. FIG. 6B is a sectional view of the tilt adjust nut 53.

As shown in FIGS. 6A and 6B, the tilt adjust nut 53 has a cylindrical outer shape, and has a threaded hole 53a and a retention hole 53b. The threaded hole 53a extends perpendicularly to the axial direction of the cylindrical tilt adjust nut 53, and penetrates a lateral peripheral face so as to pass an axial center. The retention hole 53b is formed in one end face of the tilt adjust nut 53 and extends parallel to the axial direction of the cylindrical tilt adjust nut 53 and perpendicularly to the threaded hole 53a. The threaded hole 53a has a female thread formed therein, and this female thread is screwed onto a male thread formed along the tilt screw 52. The retention hole 53b communicates with the threaded hole 53a. Further, the other end face of the tilt adjust nut 53 is closed.

As shown in FIG. 4, the tilt adjust nut 53 shaped as shown in FIGS. 6A and 6B is inserted in the cylindrical first recess 422a formed in the tilt tubular portion 422 of the tube guide bracket 42. The tilt adjust nut 53 is coupled to the tube guide bracket 42 rotatably around the axis of the tilt adjust nut 53 in the first recess 422a. In the assembled state, the direction of the axis of rotation of the tilt adjust nut 53 is the same as the axial direction of the first recess 422a. The axial direction of the first recess 422a is parallel to the axial direction (the lateral direction in FIG. 4) perpendicular to the tilt plane of the column body 10. Therefore, the tilt adjust nut 53 is coupled to the tube guide bracket 42 as a support member, rotatably around an axis perpendicular to the tilt plane of the column body 10 (around the axis parallel to the tilt axis) in the first recess 422a.

Further, the tilt adjust nut 53 is inserted in the tilt tubular portion 422 such that the threaded hole 53a of the tilt adjust nut 53 is axially superimposed on the second recess of the tilt tubular portion 422. In this insertion state, the tilt screw 52 is inserted through the second recess 422b and screwed into the tilt adjust nut 53 through the threaded hole 53a. The second recess 422b is formed in the shape of an elongated hole as described above, and has a gap in a radial direction of the tilt screw 52 when the tilt screw 52 is inserted.

Further, the retention hole 53b of the tilt adjust nut 53 is provided with a press holder 55 and a press spring 56. The press spring 56 is disposed in the retention hole 53b along the axial direction thereof. One end of the press spring 56 is fixed to a bolt 57 mounted to an opening edge of the retention hole 53b, and the other end thereof is fixed to the press holder 55. The press holder 55 is disposed face to face with a lateral periphery of the tilt screw 52. A curved face with a circular cross section is formed on the face of the press holder 55 that faces the tilt screw 52. The curved face corresponds to the outer shape of the tilt screw 52. The press spring 56 exerts a tensile force in the state shown in FIG. 4. Accordingly, the press holder 55 urges the tilt screw 52 due to the tensile force of the press spring 56. Thus, the tilt screw 52 is pressed against an inner peripheral wall of the threaded hole 53a on the other side of the press holder 55. The female thread is formed along the inner peripheral wall of the threaded hole 53a. Therefore, due to the pressing of the tilt screw 52, the male thread of the tilt screw 52 is reliably screwed into the threaded hole 53a. Accordingly, the backlash between the tilt screw 52 and the tilt adjust nut 53 may be eliminated through the above-mentioned urging force.

As shown in FIG. 4, the tilt adjust nut 53 is inserted in the first recess 422a, but the right portion of the tilt adjust nut 53 protrudes from the first recess 422a. The protruding region is mounted with a tilt guide bushing 53c to cover the outer periphery of the tilt adjust nut 53. The tilt guide bushing 53c has a rectangular outer shape as is the case with the tilt guide bushing 424c mounted to the head portion of the tilt guide pin 424b, and is fitted in a guide hole 33a formed in a lateral wall portion 33 of the upper bracket 30. A lateral strip of the tilt guide bushing 53c is guided by the guide hole 33a, and the tilt guide bushing 53c is thereby made vertically movable and longitudinally (in the column axis direction) immovable. As described above, the column body 10 is structured to be entirely supported from both lateral sides thereof by the upper bracket 30 via the tube guide bracket 42, the tilt adjust nut 53, and the like due to the receiving of the tilt guide bushings 424c and 53c by the surfaces of the guide holes 32a and 33a of the lateral wall portions 32 and 33.

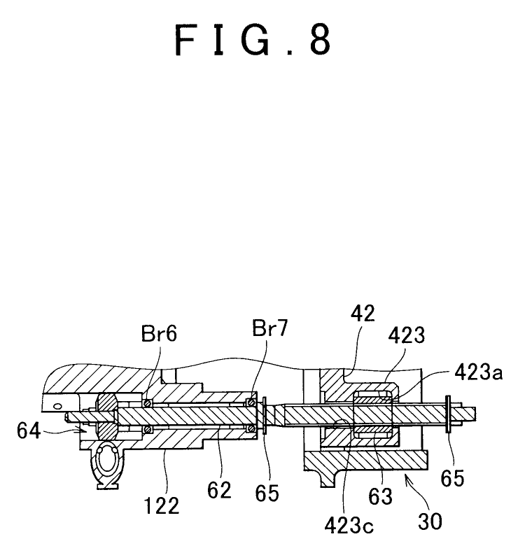

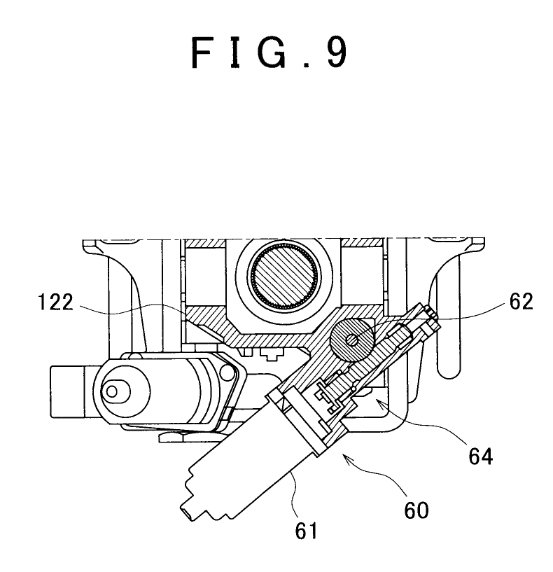

As shown in FIGS. 8 and 9, the electric telescoping mechanism 60 is constructed with a telescopic electric motor 61, the telescopic screw 62, and the telescopic adjust nut 63. FIG. 8 is a sectional view taken along a line VIII-VIII of FIG. 1. FIG. 9 is a sectional view taken along a line IX-IX of FIG. 1. FIGS. 8 and 9 both show a mounted state of the electric telescoping mechanism 60. As shown in FIGS. 1, 8, and 9, the electric motor 61 of the electric telescoping mechanism 60 is fixed to the yoke portion 122 of the column tube 12. The electric motor 61 is coupled to the telescopic screw 62 via a speed reduction mechanism 64 such as a worm reducer or the like, which is composed of a worm shaft and a worm wheel. The telescopic screw 62 extends in the column axis direction of the column body 10, and has a male thread formed along the outer periphery thereof. Further, as shown in FIG. 8, the telescopic screw 62 is rotatably and axially immovably supported on its left side in FIG. 8 by the yoke portion 122 via bearings Br6 and Br7, and is inserted on its right side in FIG. 8 through a recess 423c formed in a telescopic support portion 423 of the tilt guide bracket 42. Further, a pair of longitudinally arranged stoppers 65 and 65 for regulating the amount of movement of the column tube 12 with respect to the tube guide bracket 42 in the column axis direction through abutment on the tube guide bracket 42 are assembled with an outer periphery of the telescopic screw 62.

As shown in FIG. 8, the telescopic adjust nut 63 is inserted in the recess 423a of the telescopic support portion 423, and is immovably elastically supported by the telescopic support portion 423 via the elastic body 423b that prevents slippage as described above. A threaded hole 63a, in which a female thread is provided along its inner periphery, is formed in telescopic adjust nut 63 (see FIG. 4). The threaded hole 63a extends in the column axis direction of the column body 10 in a state where the telescopic adjust nut 63 is mounted in the recess 423a. Then, the telescopic screw 62 inserted through the telescopic support portion 423 is screwed into the telescopic adjust nut 63 through the threaded hole 63a. Further, a retention hole 63b is additionally formed in the telescopic adjust nut 63. The retention hole 63b extends upward in FIG. 4 from an open end side of the recess 423a and perpendicular to the threaded hole 63a. Furthermore, the tip of the retention hole 63b communicates with the threaded hole 63a. The press holder 65 and the press spring 66 are disposed in the retention hole 63b, and a bolt 67 is fixed to an open end of the retention hole 63b. The backlash between the telescopic screw 62 and the telescopic adjust nut 63 may be eliminated through the press holder 65, the press spring 66, and the bolt 67. The structures of the press holder 65, the press spring 66, and the bolt 67 are identical to those of the press holder 55, the press spring 56, and the bolt 57, and hence will not be described in detail.

As shown in FIG. 4, the upper plate portion 31 of the upper bracket 30 has an upper support portion 31a having a region to which the bearing Br4, supporting an upper end of the tilt screw 52 as shown in FIG. 4, is fixed. The upper bracket 30 also has a pair of mounting portions 31b, which protrude horizontally and laterally in FIG. 4 from the upper support portion 31a. Slit holes 31c are formed in each mounting portion 31b. The slit holes 31c allow the upper bracket 30 to move in the forward direction of the vehicle in the event a secondary collision occurs. The slit holes 31c extend from center of each mounting portions 31b in the rearward direction of the vehicle. The rear end of each slit hole 31c is open. The slit holes 31c and 31c are mounted with a pair of laterally arranged capsules 31d and 31d respectively.

Together with a pair of laterally arranged energy absorption plates 37, the capsules 31d are attached to the vehicle body via a pair of laterally arranged coupling bolts (not shown). The coupling bolts, may be, for example, screwed to nuts that are welded to the vehicle body. Further, the mounting portions 31b are coupled to the capsules 31d respectively by pins (not shown) that shear under a load (an impact load acting forward with respect to the vehicle) equal to or larger than a threshold shearing load, a leaf spring exerting an elastic force of about the above-mentioned predetermined value of approximately equal magnitude as the threshold shearing load, or the like. When a load equal to or larger than the threshold shearing load acts on the upper bracket 30, the upper bracket 30 separates from both the capsules 31d and 31d in the forward direction of the vehicle. Each energy absorption plate 37 is secured one end, together with a corresponding capsules 31d, to part of the vehicle body by a coupling bolt (not shown). When the upper bracket 30 separates from both the capsules 31d and moves forward with respect to the vehicle, the energy absorption plates 37 are wiped by wiping pins 38 (see FIG. 1) assembled with the upper bracket 30 respectively, thereby absorbing impact energy.

In the steering column device 1 constructed as described above, when the telescopic electric motor 61 is driven, the telescopic screw 62, which is coupled to the telescopic electric motor 61 via the speed reduction mechanism 64, rotates. When the telescopic screw 62 is rotating, the telescopic adjust nut 63, screwed to the telescopic screw 62, is immovably elastically supported by the telescopic support portion 423. Therefore, the telescopic screw 62 axially moves while rotating.

The yoke portion 122 supporting the telescopic screw 62, the tube body 121 coupled to the yoke portion 122, and the upper shaft 111 supported by the tube body 121 move due to axial movement of the telescopic screw 62. Thus, with the exception of the lower shaft 112, the column body 10 moves in the longitudinal direction of the vehicle (i.e., in the column axis direction) to perform telescoping operation. Accordingly, the upper shaft 111 axially moves with respect to the lower shaft 112. Further, the lower bracket 20 and the upper bracket 30 are fixed to the vehicle body side, and hence do not move due to the above-mentioned telescoping operation. In addition, the tilt guide bushings 424c and 53c are fitted in the guide holes 32a and 33a of the upper bracket 30 and are stopped from moving in the column axis direction. Therefore, the telescoping operation also does not move the tube guide bracket 42 and the tube guide bushing 41, with which the tilt guide bushings 424c and 53c are assembled, in the column axis direction. Therefore, during the telescoping operation, the tube body 121 moves axially while remaining in sliding contact with the tube guide bushing 41 against a fastening force (sliding resistance) generated between the tube body 121 and the tube guide bracket 42 by the fastening bolt 43. Further, during the telescoping operation, the tilt center pin 23, mounted on the lower bracket 20, moves in the column axis direction in the slit hole 122b formed in the arm portion 122a of the yoke portion 122. It is thereby possible to move the column tube 12 in the axial direction with respect to the lower bracket 20.

Further, when the tilt electric motor 51 is driven, the tilt screw 52, which is coupled to the tilt electric motor 51 via the speed reduction mechanism 54, rotates. The tilt screw 52 is rotatably and axially immovably supported by the upper bracket 30. Therefore, the tilt adjust nut 53 screwed onto the tilt screw 52 is fed through rotation of the tilt screw 52, and moves along the axial direction of the tilt screw 52. The tube guide bracket 42 and the tube guide bushing 41, which are coupled to the tilt adjust nut 53, also move due to the movement of the tilt adjust nut 53. In addition, the tube body 121, which is fastened to the tube guide bracket 42, moves as well. Thus, the column body 10, which includes the tube body 121, the yoke portion 122, the upper shaft 111, and the lower shaft 112, vertically tilts with respect to the vehicle body around a point (support point) where the column body 10 is supported by the lower bracket 20 via the tilt center pins 23, thereby performing tilt operation. Accordingly, the tilt guide bushings 424c and 53c move vertically in the guide holes 32a and 33a, which are formed in the lateral wall portions 32 and 33 of the upper bracket 30.

Further, when the column body 10 is tilted via the above-described tilt operation, the tilt angle of the column body 10 and the tube guide bracket 42 with respect to the upper bracket 30 changes. In accordance with changes in this tilt angle, the tilt adjust nut 53, mounted on the tube guide bracket 42, rotates around the axis perpendicular to the tilt plane of the column body 10 (i.e., around the axis parallel to the tilt axis) in the first recess 422a. Due to rotation of the tilt adjust nut 53, the tube guide bracket 42 may be tilted in the tilt plane in accordance with tilt operation of the column body 10. That is, due to rotation of the tilt adjust nut 53, the column body 10 and the components that tilt together with the tilt adjust nut 53 (the tube guide bracket 42 and the tube guide bushing 41) may be tilted with respect to the upper bracket 30 and the components fixed thereto (the tilt screw 52 and the tilt adjust nut 53)

In a conventional steering column device, to allow the column body to tilt with respect to the upper bracket in accordance with tilt operation, the upper bracket is tiltably mounted to a member on the vehicle body via a hinge. Thus, it is necessary to provide a hinge. Therefore, problems such as increases in the cost, the size of the steering column device, and the like, arise as a result of an increase in the number of components. On the other hand, in the foregoing embodiment of the invention, the tilt adjust nut 53 is rotatably coupled to the member which tilts due to tilt operation around the axis perpendicular to the tilt plane. During tilt operation, the tilt adjust nut 53 itself is used as a hinge member by being rotated. Therefore, there is no need to provide a separate hinge. Thus, the number of components may be reduced, and a reduction in size can be achieved.

The column body 10 tilts around the support point where the lower bracket 20 is supported by the tilt center pin 23. On the other hand, the tilt adjust nut 53 rectilinearly moves along the axial direction of the guide hole 33a of the upper bracket 30 as the tilt guide bushing 53c moves. Thus, before and after tilt operation, the distance from the support point to the tilt adjust nut 53 changes in the axial direction of the column body 10. This change in the axial direction is allowed (absorbed) through the axial movement of the upper shaft 111 (and the column tube 12) with respect to the lower shaft 112, namely, the axial movement of the tilt center pins 23 through the slit holes 122b of the yoke portion 122 as during telescoping operation.

As described above, according to the steering column device 1 of this embodiment of the invention, the first recess 422a is formed in the tube guide bracket 42 as the support member for supporting the steering main shaft 11, and the tilt adjust nut 53 is inserted in this first recess 422a and coupled rotatably around the axis perpendicular to the tilt plane of the column body 10. Accordingly, even when the column body 10 tilts with respect to the upper bracket 30 and thus changes the tilt angle of the column body 10 with respect to the upper bracket 30, the tilt adjust nut 53 rotates in the first recess 422a in accordance with the tilting of the column body 10, thereby allowing the tilt angle to change. That is, the tilt adjust nut 53 itself serves as a hinge and hence allows the column body 10 to tilt. Thus, unlike conventional steering column devices, the hinge member is not required. As a result, the number of components of the steering column device 1 may be reduced, and the steering column device 1 may be made compact.

Further, the tilt tubular portion 422 formed in the tube guide bracket 42 has the second recess 422b formed in a penetrating manner perpendicularly to the first recess 422a, and the tilt screw 52 is inserted through the second recess 422b. Thus, the tilt screw 52 may be disposed closer to the column body 10. Accordingly, the size of the steering column device 1 may be further reduced, and the rigidity of the steering column device 1 is increased when the column body 10 and the tilt screw 52 have been assembled with each other. Further, the first recess 422a and the second recess 422b intersect with each other in the tilt tubular portion 422. Thus, the axial length of the first recess 422a may be lengthened. Accordingly, the axial length of the tilt adjust nut 53 and the tilt tubular portion 422 may also be lengthened, thereby improving rigidity of the steering column device 1 when the tilt adjust nut 53 and the tilt tubular portion 422 have been assembled with each other.

Further, as shown in FIG. 5E, the axially extending slit 421a is formed in the guide portion 421, the tube guide bracket 42 is equipped with the pair of the protruding strips 425a and 425b, which face each other at both edge portions of the guide portion 421, across the slit 421a. The protruding strips may be fastened to tube guide bracket 42 using, for example, a fastening bolt 43. Thus, the backlash (e.g., the gap resulting from a dimensional error) between the tube guide bracket 42 and the column tube 12 (the tube body 121) may be eliminated or the sliding load in performing telescoping operation may be set by adjusting the fastening force (fastening torque) exerted by the fastening bolt 43.

Further, the tilt adjust nut 53 has the threaded hole 53a screwed onto the tilt screw 52, and the retention hole 53b communicating with this threaded hole 53a and formed perpendicularly to the axial direction of the threaded hole 53a. The press means composed of the press holder 55 and the press spring 56 is disposed in this retention hole 53b. Thus, the tilt screw 52 is pressed against the wall surface of the threaded hole 53a by the press means, and the rattling between the tilt screw 52 and the tilt adjust nut 53 is thereby prevented. By the same token, the press means is also disposed for the telescopic adjust nut 63. Thus, the rattling between the telescopic screw 62 and the telescopic adjust nut 63 is also prevented.

If the impact force resulting from a secondary collision to the rear of the vehicle acts on the steering column device 1, the impact force is input to the column body 10 and is further transmitted to the upper bracket 30 via the tube guide bracket 42, the tilt adjust nut 53, and the tilt screw 52. Then, when that component of the transmitted impact force, which acts in the column axis direction, exceeds a set load, the upper bracket 30 separates from the capsules 31d and axially moves together with the column body 10.

In this case, in a steering column device equipped with an electric tilt mechanism, especially in a steering column device having a tilt screw supported by an upper bracket as an electric tilt mechanism, the impact force from a secondary collision is transmitted from the column body to the upper bracket via the tilt screw. In contrast, in a conventional steering column device, the upper end support point and the lower end support point, where the tilt screw is supported by the upper bracket, are located below the separation points (mounting portions) of the upper bracket and the capsules. Thus, the resulting torque pushes the upper bracket up and acts on the separation points due to the above-mentioned impact force. Due to the influence of this torque, the separation load of the upper bracket may be momentarily destabilized.

On the other hand, according to the steering column device 1 of this embodiment of the invention, as shown in FIG. 4, the upper end support point (i.e., the vertical position of the upper support portion 31a of the upper plate portion 31), which is the region where the upper end of the tilt screw 52 is supported by the upper bracket 30 via the bearing Br4, is located above the separation point of the upper bracket 30 (i.e., the vertical position of the mounting portion 31b of the upper plate portion 31), and the region where the lower end of the tilt screw 52 is supported by the upper bracket 30, via the bearing Br5 (the lower end support point), is located below the separation point of the upper bracket 30. That is, the separation point of the upper bracket 30 according to this embodiment of the invention is located between the upper end support point and the lower end support point. Accordingly, when an impact force is transmitted to the upper bracket 30 via the tilt screw 52, a torque that pushes up on the upper bracket 30 from the lower end support point of the tilt screw 52, whereas a torque that pushes down on the upper bracket 30 from the upper end support point of the tilt screw 52. The torques thus act on the upper bracket 30 in opposite directions from the upper end support point and the lower end support point. Therefore, the torques acting on the upper bracket 30 are counterbalanced by each other. Thus, the net torque acting on the upper bracket 30 is reduced, and the separation load of the upper bracket 30 is thereby stabilized.

Although the embodiment of the invention has been described above, the invention should not be construed as being limited to the described embodiment. For example, in the foregoing embodiment of the invention, the example in which the invention is applied to the steering column device capable of performing telescoping operation has been described. However, the invention is also applicable to a steering column device that does not include a telescoping mechanism. In this case, there is no need to axially mount a movable tube guide bracket on the column body. Therefore, in order for a tilt adjust nut to be directly mounted to a column body (column tube), a tubular portion that protrudes laterally from the column tube may be formed, a first recess is formed in this tubular portion, and the tilt adjust nut is directly inserted in the first recess. In addition, the invention may be applied to other modified embodiments so long as the modified embodiments fall within the scope of the invention as defined by the appended claims.

What is claimed is:

1. A steering column device comprising:
a steering column body that includes a steering main shaft, which is coupled to a steering wheel, and a support member that rotatably supports the steering main shaft;
a lower bracket, fixed to a vehicle body, that tiltably supports the steering column body with respect to the vehicle body;
an upper bracket that is mounted on the vehicle body to support the steering column body at a position behind the lower bracket in the longitudinal direction of the vehicle body to allow the steering column body to tilt; and
an electric tilt mechanism that tilts the steering column body with respect to the vehicle body around a point where the steering column body is supported by the lower bracket, wherein the electric tilt mechanism includes a tilt screw that extends perpendicularly to or at a slant with respect to an axis of the steering column body, has a male thread provided along an outer periphery, and is rotatably and axially immovably supported by the upper bracket, an electric actuator that rotationally drives the tilt screw, and a tilt adjust nut that has a threaded hole having a female thread provided along an inner periphery thereof and is screwed onto the tilt screw, wherein:
a first recess, in which the tilt adjust nut is inserted, is formed in the support member; and
the tilt adjust nut is rotatably coupled to the support member around an axis perpendicular to a tilt plane of the steering column body in the first recess.

2. The steering column device according to claim 1, wherein:
the first recess extends perpendicularly to the tilt plane; and
a tubular portion that is formed on the support member having the first recess formed therein, and that extends perpendicularly to the tilt plane.

3. The steering column device according to claim 2, wherein:
a second recess is formed in the tubular portion that is perpendicular to the first recess; and
the tilt screw is inserted through the second recess.

4. The steering column device according to claim 1, wherein:
the tilt adjust nut has a retention hole that communicates with the threaded hole and is perpendicular to an axial direction of the threaded hole; and
a press portion, disposed in the retention hole, presses the tilt screw, which is screwed into the tilt adjust nut through the threaded hole, in a radial direction of the tilt screw.

5. The steering column device according to claim 2, wherein
the support member has
a column tube that is formed in tubular shape, and that rotatably and axially immovably supports the steering main shaft on an inner periphery side thereof;
a tube guide bracket that covers an outer periphery of the column tube, that tiltably supports the column tube and allows movement of the column tube in its axial direction, and is assembled with the upper bracket movably in an axial direction of the tilt screw and immovably in an axial direction of the column tube; and
the tubular portion is formed in the tube guide bracket.

6. The steering column device according to claim 1, wherein
the upper bracket has:
a mounting portion that is mounted on the vehicle body;
an upper support portion that rotatably and axially immovably supports the tilt screw at a position above the location where the upper bracket is screwed to the tilt adjust nut;
a lower support portion that rotatably and axially immovably supports the tilt screw at a position below the position where the upper bracket is screwed to the tilt adjust nut;
the upper support portion is located on the steering column body above the mounting portion, and
the lower support portion is located on the steering column body below the mounting portion.
